(19) United States
(12) Patent Application Publication
(10) Pub. No.: US 2025/0062369 A1
(43) Pub. Date: Feb. 20, 2025

(54) INTERCONNECT FOR A FUEL CELL STACK AND METHOD OF OPERATING THE STACK

(71) Applicant: Bloom Energy Corporation, San Jose, CA (US)

(72) Inventors: Muthiah Annamalai RAMAN, Mumbai (IN); Natarajan RAMANAN, San Jose, CA (US); Nilanjana BASU, Santa Clara, CA (US)

(21) Appl. No.: 18/804,903

(22) Filed: Aug. 14, 2024

(30) Foreign Application Priority Data
Aug. 16, 2023 (IN) 202341054902

(51) Int. Cl. H01M 8/0258; H01M 8/04014; H01M 8/0612; H01M 8/0662; H01M 8/12; H01M 8/2425; H01M 8/2483

(52) U.S. Cl. CPC H01M 8/0258; H01M 8/04014; H01M 8/0618; H01M 8/0662; H01M 8/2425; H01M 8/2483; H01M 2008/1293

(57) ABSTRACT

An interconnect for a fuel cell system includes at least one fuel inlet opening, such that more than 50% of a total fuel inlet opening area is located in one lateral half of the interconnect which is closer to a higher temperature component of the fuel cell system, while less than 50% of the total fuel inlet opening area is located in the other lateral half of the interconnect which is closer to a lower temperature component of the fuel cell system. In the fuel cell system, an endothermic fuel reformation reaction occurs at a fuel cell anode near the at least one fuel inlet opening to selectively cool the lateral half of the interconnect which is closer to the higher temperature component to reduce a temperature gradient across the interconnect.

### FIELD

The present disclosure generally relates to an interconnect for an electrochemical cell stack, and more particularly to an interconnect for a fuel cell stack and method of operating the stack.

### BACKGROUND

An electrochemical cell may be used to produce electrical energy from chemical energy and chemical energy from electrical energy. A fuel cell is an electrochemical cell that may convert the chemical energy of a fuel (e.g., hydrogen or hydrocarbon fuel) and an oxidizing agent (e.g., air or oxygen) into electricity. An electrolysis cell is an electrochemical cell that may use electricity to drive a chemical reaction (e.g., decomposition of water into hydrogen and oxygen).

The electrochemical cell may include an anode, a cathode and an electrolyte between the anode and cathode that allows ions (e.g., hydrogen ions, oxygen ions, etc.) to move between the anode and cathode. The electrochemical cell may have substantially planar shape in which case the anode, cathode and electrolyte may be formed as layers in the electrochemical cell. This may allow a plurality of the electrochemical cells to be stacked together to form an electrochemical cell stack (e.g., fuel cell stack, electrolysis cell stack, etc.).

The electrochemical cells in the electrochemical cell stack may be separated by interconnects. The interconnects may serve as gas flow separator plates that separate a gas at the anode of an electrochemical cell from a gas at the cathode of an adjacent electrochemical cell in the stack.

### SUMMARY

According to an aspect of the present disclosure, an interconnect for a fuel cell system comprises a plate portion, having a first end and a second end opposite the first end in a first direction, a third end and a fourth end opposite the third end in a second direction perpendicular to the first direction, at least one fuel inlet opening and at least one fuel outlet opening in the plate portion, and a plurality of fuel channels connecting the at least one fuel inlet opening to the at least one fuel outlet opening. The interconnect comprises a first lateral half and a second lateral half separated by an imaginary plane which is normal to the first direction and which bisects the interconnect midway along the first direction. The first lateral half is configured to be located closer to a first component than to a second component of the fuel cell system when the interconnect is located in a fuel cell stack located in the fuel cell system. The second lateral half is configured to be located closer to the second component than to the first component of the fuel cell system when the interconnect is located in the fuel cell stack located in the fuel cell system. More than 50% of a total fuel inlet opening area is located in the second lateral half of the interconnect, and the first component operates at a lower temperature than the second component during operation of the fuel cell system.

According to another aspect of the present disclosure, a method of operating a fuel cell system comprises providing a fuel inlet stream and an air inlet stream into a fuel cell stack having a first side and a second side, wherein the fuel cell stack comprises fuel cells alternating with interconnects, reforming fuel from the fuel inlet stream at anodes of the fuel cells, operating a first component of the fuel cell system at a first temperature, and operating a second component of the fuel cell system at a second temperature higher than the first temperature. The first side of the fuel cell stack faces the first component and the second side of the fuel cell stack faces the second component, and greater than 50% of the fuel reformation at the anodes of the fuel cells occurs in a second half of the fuel cell stack between the second side of the fuel cell stack and a middle of the fuel cell stack.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell system, according to various embodiments of the present disclosure.

FIG. 2A is a sectional view showing various components of a hotbox of the system of FIG. 1, FIG. 2B shows an enlarged portion of the hotbox of FIG. 2A, and FIG. 2C is a three-dimensional cut-away view of a central column of the hotbox and base components of the system of FIG. 2A.

FIG. 3A is an exploded perspective view of a prior art fuel cell stack 320.

FIG. 3B is a top view of the fuel side of a prior art interconnect 400 included in the prior art fuel cell stack 320.

FIG. 3C is a schematic view of a fuel cell 310 included in the prior art fuel cell stack 320.

FIG. 4 illustrates a fuel cell stack 620 according to the first embodiment of the present disclosure.

FIG. 5A is a plan view of the air side 601 of the interconnect 500, according to the first embodiment.

FIG. 5B is a plan view of the fuel side 602 of the interconnect 500, according to the first embodiment.

FIG. 6A is a plan view of a riser seal 661 on the air side 601 of the interconnect 500, according to the first embodiment.

FIG. 6B is a plan view of a perimeter seal 662 on the fuel side 602 of the interconnect 500, according to the first embodiment.

FIG. 7 illustrates a fuel cell column 700 according to various embodiments.

FIG. 8 is a plan view of the fuel side 602 of the interconnect 500′ according to the second embodiment.

FIG. 9 is a plan view of the fuel side 602 of the interconnect 500″ according to the third embodiment.

### DETAILED DESCRIPTION

The various embodiments will be described in detail with reference to the accompanying drawings. The drawings are not necessarily to scale, and are intended to illustrate various features of the invention. Wherever possible, the same reference numbers will be used throughout the drawings to refer to the same or like parts. References made to particular examples and implementations are for illustrative purposes, and are not intended to limit the scope of the invention or the claims.

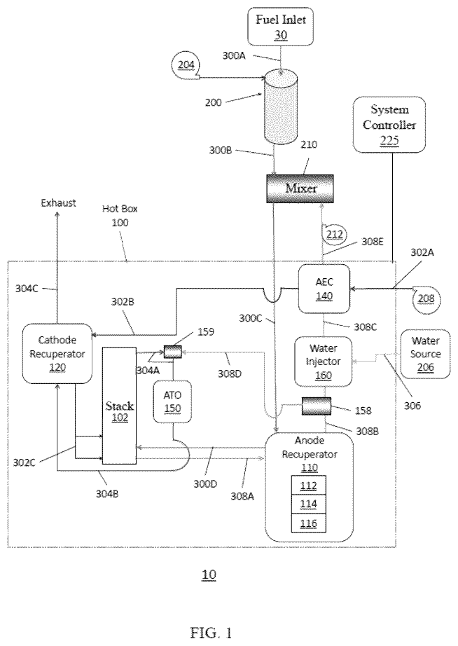

FIG. 1 is a schematic representation of a solid oxide fuel cell (SOFC) system 10, according to various embodiments of the present disclosure. Referring to FIG. 1, the system 10 includes a hotbox 100 and various components disposed therein or adjacent thereto. The hotbox 100 may contain stacks (e.g., fuel cell stacks) 102 containing alternating fuel cells, such as solid oxide fuel cells, and interconnects. Thus, in one embodiment, the stacks 102 may comprise SOFC stacks. One solid oxide fuel cell of the stack 102 contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode (i.e., an anode), such as a nickel-YSZ, a nickel-SSZ or nickel-doped ceria cermet, and a cathode electrode (i.e., a cathode), such as lanthanum strontium manganite (LSM). The interconnects may be metal alloy interconnects, such as chromium-iron alloy interconnects. The stacks 102 may be internally or externally manifolded for fuel, and may be arranged over each other in a plurality of columns.

The hotbox 100 may also contain an anode recuperator heat exchanger 110, a cathode recuperator heat exchanger 120, an anode tail gas oxidizer (ATO) 150, an anode exhaust cooler heat exchanger 140, a splitter 158, a vortex generator 159, and a water injector 160. The system 10 may also include a catalytic partial oxidation (CPOx) reactor 200, a mixer 210, a CPOx blower 204 (e.g., air blower), a main air blower 208 (e.g., system blower), and an anode recycle blower 212, which may be disposed outside of the hotbox 100. However, the present disclosure is not limited to any particular location for each of the components with respect to the hotbox 100.

The CPOx reactor 200 receives a fuel inlet stream from a fuel inlet 30, through fuel conduit 300A. The fuel inlet 30 may be a fuel tank or a utility natural gas line including a valve to control an amount of fuel provided to the CPOx reactor 200. The CPOx blower 204 may provide air to the CPOx reactor 200 during system start-up. The fuel and/or air may be provided to the mixer 210 by fuel conduit 300B. Fuel (e.g., the fuel inlet stream) flows from the mixer 210 to the anode recuperator 110 through fuel conduit 300C. The fuel is heated in the anode recuperator 110 by a portion of the fuel exhaust and the fuel then flows from the anode recuperator 110 to the stack 102 through fuel conduit 300D.

The main air blower 208 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C.

An anode exhaust stream (e.g., the fuel exhaust stream) generated in the stack 102 is provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 158 by anode exhaust conduit 308B. A first portion of the anode exhaust may be provided from the splitter 158 to the anode exhaust cooler 140 through the water injector 160 and the anode exhaust conduit 308C. A second portion of the anode exhaust may be provided from the splitter 158 to the ATO 150 through the anode exhaust conduit 308D. The first portion of the anode exhaust heats the air inlet stream in the anode exhaust cooler 140 and may then be provided from the anode exhaust cooler 140 to the mixer 210 through the anode exhaust conduit 308E. The anode recycle blower 212 may be configured to move anode exhaust through anode exhaust conduit 308E, as discussed below.

Cathode exhaust generated in the stack 102 flows to the ATO 150 through exhaust conduit 304A. The vortex generator 159 may be disposed in exhaust conduit 304A and may be configured to swirl the cathode exhaust. The anode exhaust conduit 308D may be fluidly connected to the vortex generator 159 or to the cathode exhaust conduit 304A or the ATO 150 downstream of the vortex generator 159. The swirled cathode exhaust may mix with the second portion of the anode exhaust provided by the splitter 158 before being provided to the ATO 150. The mixture may be oxidized in the ATO 150 to generate an ATO exhaust. The ATO exhaust flows from the ATO 150 to the cathode recuperator 120 through exhaust conduit 304B. Exhaust flows from the cathode recuperator and out of the hotbox 100 through exhaust conduit 304C.

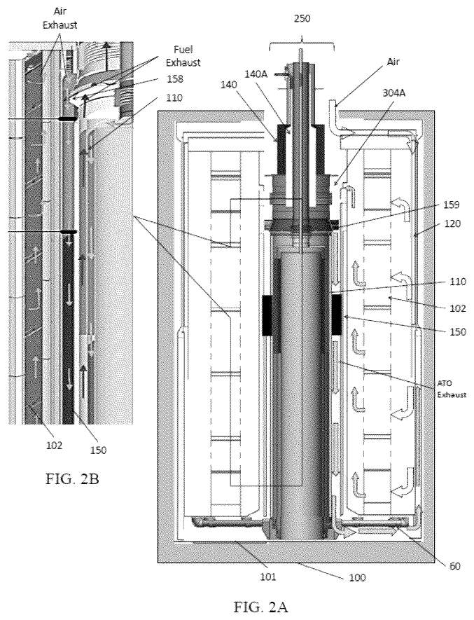

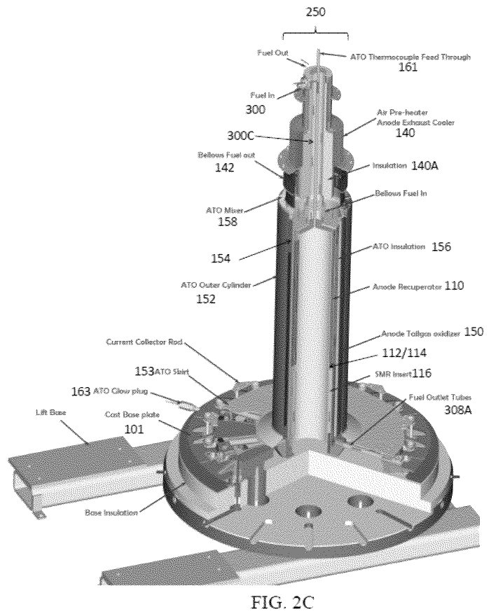

During system startup, a heat source may be used to initiate an oxidation reaction in the ATO 150. In various embodiments, the system 10 may include an ATO glow plug 163 (shown in FIG. 2C) configured to heat the fuel mixture provided to the ATO 150. The ATO glow plug 163 may be fluidly connected upstream of the ATO 150 and may be sealed within an opening in the housing of the hotbox 100.

Water flows from a water source 206, such as a water tank or a water pipe, to the water injector 160 through water conduit 306. The water injector 160 injects water directly into a first portion of the anode exhaust provided in anode exhaust conduit 308C. Heat in the first portion of the anode exhaust (also referred to as a recycled anode exhaust stream) present in anode exhaust conduit 308C vaporizes the water to generate steam. The steam mixes with the anode exhaust, and the resultant mixture is provided to the anode exhaust cooler 140. The mixture is then provided from the anode exhaust cooler 140 to the mixer 210 through the anode exhaust conduit 308E. The mixer 210 is configured to mix the steam and first portion of the anode exhaust with fresh fuel (i.e., fuel inlet stream). This humidified fuel mixture may then be heated in the anode recuperator 110 by the anode exhaust, before being provided to the stack 102. The system 10 may also include one or more fuel reforming catalysts 112, 114, and 116 located inside and/or downstream of the anode recuperator 110. The reforming catalyst(s) reform the humidified fuel mixture before it is provided to the stack 102.

The system 10 may further include a system controller 225 configured to control various elements of the system 10. The controller 225 may include a central processing unit configured to execute stored instructions. For example, the controller 225 may be configured to control fuel and/or air flow through the system 10, according to fuel composition data.

FIG. 2A is a sectional view showing components of the hotbox 100 of the system 10 of FIG. 1, and FIG. 2B shows an enlarged portion of FIG. 2A. FIG. 2C is a three-dimensional cut-away view of a central column 250 of the hotbox 100 and base components of the system 10, according to various embodiments of the present disclosure.

Referring to FIGS. 2A-2C, the fuel cell stacks 102 may be disposed around the central column 250 in the hotbox 100. For example, the stacks 102 may be disposed in a ring configuration around the central column 250 and may be positioned on the hotbox base 101. The column 250 may include the anode recuperator 110, the ATO 150, and the anode exhaust cooler 140. In particular, the anode recuperator 110 is disposed radially inward of the ATO 150, and the anode exhaust cooler 140 is mounted over the anode recuperator 110 and the ATO 150. Anode exhaust cooler inner core insulation 140A may be located between the fuel conduit 300C and the combination of the anode exhaust cooler 140 and the bellows 142 underlying the anode exhaust cooler 140. In one embodiment, an oxidation catalyst 112 and/or the hydrogenation catalyst 114 may be located in the anode recuperator 110. A reforming catalyst 116 may also be located at the bottom of the anode recuperator 110 as a steam methane reformation (SMR) insert.

The ATO 150 comprises an outer cylinder 152 that is positioned around the outer wall of the anode recuperator 110. Optionally, ATO insulation 156 may be enclosed by an ATO inner cylinder 154. Thus, the insulation 156 may be located between the anode recuperator 110 and the ATO 150. An ATO oxidation catalyst may be located in the space between the outer cylinder 152 and the ATO insulation 156. An ATO thermocouple feedthrough 161 extends through the anode exhaust cooler 140, to the top of the ATO 150. The temperature of the ATO 150 may thereby be monitored by inserting one or more thermocouples (not shown) through this feedthrough 161.

The fuel inlet and outlet conduits 60 may be positioned under the anode recuperator 110 and ATO 150 and over the hotbox base 101. The conduits 60 are covered by an ATO skirt 153. The vortex generator 159 and fuel exhaust splitter 158 are located over the anode recuperator 110 and ATO 150 and below the anode exhaust cooler 140. The ATO glow plug 163, which initiates the oxidation of the stack fuel exhaust in the ATO during startup, may be located near the bottom of the ATO 150.

As shown by the arrows in FIGS. 2A and 2B, air enters the top of the hotbox 100 and then flows into the cathode recuperator 120 where it is heated by ATO exhaust output from the ATO 150. The ATO exhaust then flows through the cathode recuperator 120 and then exits the hotbox 100.

For solid oxide fuel cells, the heated air then flows through the stacks 102, where oxygen ions are generated and diffuse from the cathode electrodes through the fuel cell electrolytes to the anode electrodes and react with fuel (i.e., fuel inlet stream) provided from the anode inlet conduit 60 to the anode electrodes of the fuel cells. Air exhaust flows from the stacks 102 and then passes through vanes of the vortex generator 159 and is swirled before entering the ATO 150.

The splitter 158 may direct the second portion of the fuel exhaust exiting the top of the anode recuperator 110 through openings (e.g., slits) in the splitter into the swirled air exhaust (e.g., in the vortex generator 159 or downstream of the vortex generator 159 in exhaust conduit 304A or in the ATO 150). Thus, the fuel and air exhaust may be mixed before entering the ATO 150.

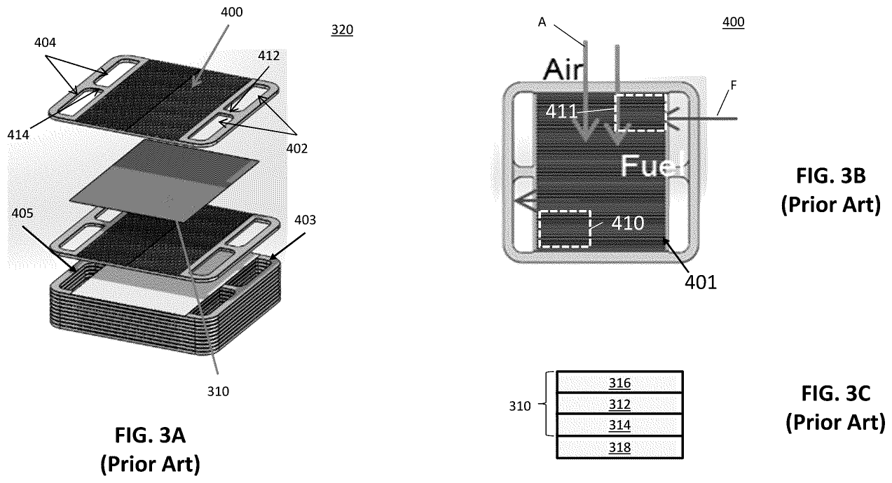

FIG. 3A is an exploded perspective view of a crossflow fuel cell stack 320, FIG. 3B is a top view of the fuel side 401 of an interconnect 400 included in the fuel cell stack 320, and FIG. 3C is a schematic view of a fuel cell 310 included in the fuel cell stack 320.

The fuel cell 310 in the crossflow fuel cell stack 320 may comprise a solid oxide fuel cell (SOFC) which includes a solid oxide electrolyte 312, an anode 314, and a cathode 316. In some embodiments, the anode 314 and the cathode 316 may be printed on the electrolyte 312.

Optionally, a conductive layer 318 (e.g., electrically conductive contact layer), such as a nickel mesh, may be disposed between the anode 314 and an adjacent interconnect 400. The fuel cell 310 does not necessarily include through holes (e.g., fuel holes) and may, therefore, avoid cracks that may be generated due to the presence of such through holes.

An uppermost interconnect 400 and a lowermost interconnect 400 of the fuel cell stack 320 may be different ones of an air end plate or fuel end plate including features for providing air or fuel, respectively, to an adjacent end fuel cell 310. As used herein, an “interconnect” may refer to either an interconnect located between two fuel cells 310 or an end plate located at an end of the fuel cell stack 320 and directly adjacent to only one fuel cell 310.

The interconnect 400 may electrically connect adjacent fuel cells 310 in the fuel cell stack 320. In particular, the interconnect 400 may electrically connect the anode 314 of one fuel cell 310 to the cathode 316 of an adjacent fuel cell 310. As shown in FIG. 3B, the interconnect 400 may be configured to channel air in a first direction A, such that the air may be provided to the cathode 316 of an adjacent fuel cell 310. The interconnect 400 may also be configured to channel fuel in a second direction F, such that the fuel may be provided to the anode 314 of an adjacent fuel cell 310. Directions A and F may be perpendicular, or substantially perpendicular. As such, the interconnect 400 may be referred to as a cross-flow interconnect.

The interconnect 400 may include through-holes configured to distribute fuel. For example, the interconnect 400 may include one or more fuel inlets 402 (e.g., fuel inlet through-holes) and one or more fuel outlets 404 (e.g., fuel outlet through-holes) which may also be referred to as anode exhaust outlets 404. The fuel inlets 402 and fuel outlets 404 may be disposed outside of the perimeter of the fuel cells 310. As such, the fuel cells 310 may be formed without corresponding through holes for fuel flow. The combined length of the fuel inlets 402 and/or the combined length of the fuel outlets 404 may be at least 75% of a corresponding length of the interconnect 400 (e.g., a length taken in direction A in FIG. 3B).

In at least one embodiment, the interconnect 400 may include two fuel inlets 402 separated by a neck portion 412 of the interconnect 400, as shown in FIG. 3A. However, more than two fuel inlets 402 may be included, such as three to five inlets separated by two to four neck portions 412. In at least one embodiment, the interconnect 400 may include two fuel outlets 404 separated by a neck portion 414 of the interconnect 400, as shown in FIG. 3A. However, more than two fuel outlets 404 may be included, such as three to five outlets separated by two to four neck portions 414.

The fuel inlets 402 of the interconnects 400 in the fuel cell stack 320 may be substantially aligned so as to constitute a fuel riser 403 in the fuel cell stack 320. The fuel outlets 404 of the interconnects 400 in the fuel cell stack 320 may also be substantially aligned so as to constitute a fuel riser 405 in the fuel cell stack 320. The fuel cell stack 320 may include at least 20 fuel cells 310 separated by respective interconnects 400. The fuel cells 310 may be provided with fuel using the fuel risers 403. Anode exhaust may be removed from the fuel cell stack 320 using fuel risers 405.

The crossflow interconnect 400 in the fuel cell stack 320 may have a higher than desired temperature gradient (e.g., thermal gradient) across the interconnect. With a crossflow configuration (e.g., where the fuel flow at the anode is substantially perpendicular to the air flow at the cathode), two distinct temperature zones 410, 411 may be formed. In particular, higher temperatures are generated at the air outlet/fuel outlet (AOFO) hot zone 410 of the interconnect 400, while lower temperatures are generated at the air inlet/fuel inlet (AIFI) cold zone 411. Since the interconnect 400 is laterally located between the warmer ATO 150 and the colder cathode recuperator 120, as shown in FIGS. 1 and 2A, the hot zone 410 is located closer to the ATO 150, while the cold zone 411 is located closer to the cathode recuperator 120.

Without wishing to be bound by a particular theory, it is believed that the higher temperatures in the hot zone 410 may be due to a hot gas outlet temperature (e.g., due to electrochemical oxidation of the fuel by the oxygen ions at the anode electrode) and the impact of anode tail gas oxidizer (ATO) radiation coupling (i.e., radiative heat from the relatively warmer ATO 150). In contrast, the lower temperatures in the cold zone 411 may be due to less radiative heating from the relatively colder cathode recuperator 120 and the endothermic fuel reformation reaction at the anode 314 facing the fuel side 401 of the interconnect 400. Thus, the exothermic reactions of the fuel cell stack coupled with warmer ATO radiative coupling versus colder cathode recuperator radiative coupling temperatures and endothermic internal fuel reformation at the fuel cell anode electrode may result in a high cell level temperature gradient across the surface of an interconnect 400 in the fuel cell stack 320, such as a gradient of 50 to 100 degrees Celsius.

In various embodiments of the present disclosure, the hydrocarbon fuel (e.g., natural gas, pure methane, biogas, etc.) used in the fuel cell stack may be reformed by an endothermic steam reformation reaction, such as a steam-methane reformation (SMR) reaction, at the anode electrode the fuel cells. The SMR reaction reforms methane fuel mixed with water into hydrogen fuel and a carbon oxide compound (e.g., CO and/or CO₂). The reformation reaction at the anode may consume more than a third of the heat produced by the electrochemical fuel oxidation reaction at the anode. In particular, the SMR reaction may consume heat energy equivalent to 206.1 KJ/mol of methane used as fuel.

The present inventors realized that the majority of the “internal” hydrocarbon fuel reformation at the anode electrode occurs in a zone where the hydrocarbon fuel initially flows over the anode electrode. Therefore, by placing the fuel inlet opening in the interconnect adjacent to a hot zone of the interconnect closer to the ATO, a significant portion (e.g., at least half) of the endothermic cooling due to the reformation reaction can be concentrated in that hot zone. Thus, the endothermic reformation reaction, such as the SMR reaction, may be localized at the hot zone of the interconnect contacting the anode electrode to reduce the temperature of the hot zone, and thus decrease the temperature gradient across the interconnect.

One or more embodiments of the present disclosure include an interconnect configured to reduce the temperature gradient across the interconnect by concentrating the endothermic fuel reformation reaction at the hot zone to reduce the maximum temperature at the hot zone of the interconnect. Specifically, the interconnect may include a fuel inlet located adjacent to the hot zone of the interconnect such that at least 50 percent of the fuel reformation reaction occurs in a vicinity of the hot zone facing the hot side (e.g., the ATO side) of the interconnect. The endothermic reformation heat requirement may be satisfied by the extra heat on the hot side of the interconnect, thereby decreasing a maximum temperature on the interconnect. The reformation reaction may substantially negate the ATO radiation coupling, which may result in a considerable decrease in the maximum temperature and the temperature gradient across the interconnect. The reduction in the temperature gradient reduces the stress on the fuel cells and reduces the chance of stress cracking of the fuel cells, such as the ceramic solid oxide fuel cells. In one embodiment, the fuel and airflow may be counterflow for the most part of the interconnect active area which may ensure more uniform air utilization and improved current density distribution.

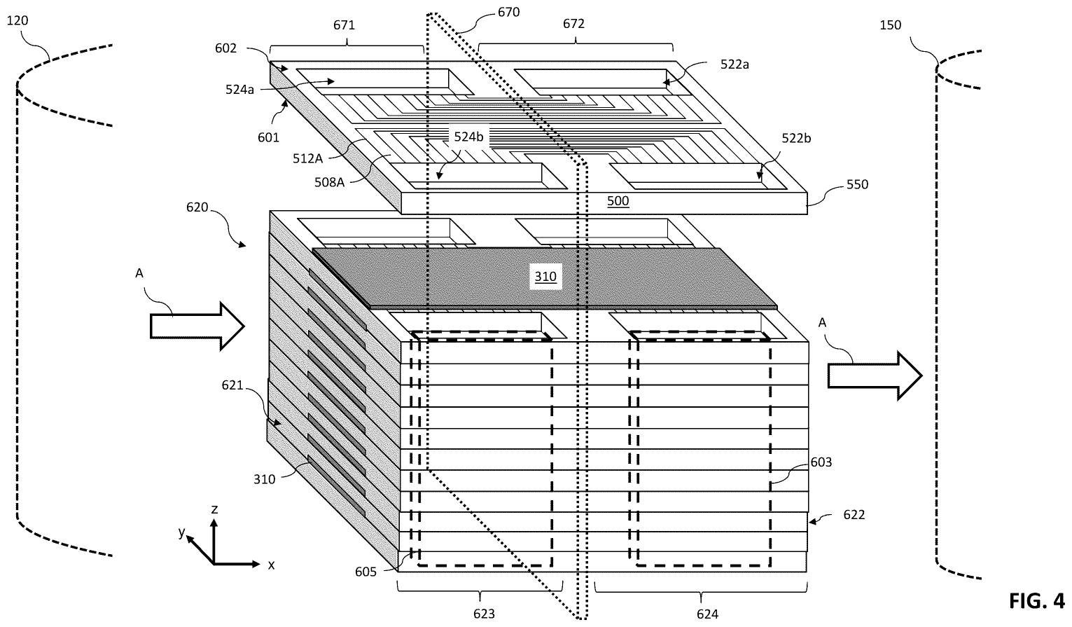

FIG. 4 illustrates a fuel cell stack 620 according to the first embodiment of the present disclosure. The fuel cell stack 620 corresponds to the fuel cell stack 102 shown in FIG. 1. The relative locations of the ATO 150 and the cathode recuperator 120 relative to the fuel cell stack 620 are shown in dashed lines in FIG. 4. The fuel cell stack 620 of the first embodiment is located between the cathode recuperator 120 and the ATO 150. The direction of the airflow from the cathode recuperator 120 through the fuel cell stack 620 and from the fuel cell stack to the ATO 150 is shown by arrows labeled “A” in FIG. 4.

The fuel cell stack 620 may include features similar to features of the crossflow fuel cell stack 320 in FIG. 3A. The fuel cell stack 620 may include a plurality of fuel cells 310 and a plurality of interconnects 500 separating the plurality of fuel cells 310. The interconnects 500 are internally manifolded for fuel and externally manifolded for air. However, in contrast to the interconnects 400 in the crossflow fuel cell stack 320, the interconnects 500 may include a fuel inlet opening, a fuel outlet opening, and fuel channels configured to reduce a temperature gradient on the interconnect 500 by concentrating the endothermic reformation reaction at the hot zone on the interconnect 500. The endothermic reaction provides cooling to the hot zone on the interconnect and thus reduces the thermal gradient across the interconnect 500.

In the first embodiment, the fuel flow and airflow may be counterflow over at least a portion of the interconnect 500 and crossflow over at least a portion of the interconnect 500. This configuration may help to ensure more uniform air utilization and improved current density distribution. The interconnect 500 may, therefore, help to decrease the cell-level temperature gradient and thereby help to reduce (e.g., minimize) cell stress and reduce the chances of cell cracking. As a result, the interconnect 500 may help to extend the life of the fuel cells 310, such as SOFCs in the fuel cell stack 620.

The fuel cells 310 in the fuel cell stack 620 may be the same as that described above with respect to the fuel cell stack 320 (e.g., see FIGS. 3A and 3C). As noted above, the fuel cell 310 may include the solid oxide electrolyte 312, the anode 314, and the cathode 316. The fuel cell 310 may also include the conductive layer 318 (e.g., nickel mesh) located between the anode 314 and an adjacent interconnect 500 and/or between the cathode 316 and an adjacent interconnect 500.

An uppermost interconnect 500 and a lowermost interconnect 500 of the fuel cell stack 620 may be different ones of an air end plate or fuel end plate including features for providing air or fuel, respectively, to an adjacent end fuel cell 310. The interconnect 500 may electrically connect adjacent fuel cells 310 in the fuel cell stack 620. In particular, the interconnect 500 may electrically connect the anode 314 of one fuel cell 310 to the cathode 316 of an adjacent fuel cell 310.

In the first embodiment, the interconnect 500 may include a plate portion 550, an air side 601 on the plate portion 550, and a fuel side 602 on the plate portion 550 opposite to the air side 601. The interconnect 500 may be configured to channel air flow (i.e., air inlet stream) along the air side 601 such that air may be provided to the cathode 316 of an adjacent fuel cell 310. The interconnect 500 may also be configured to channel fuel flow (i.e., fuel inlet stream), such as a hydrocarbon fuel flow, along the fuel side 602 such that the fuel may be provided to the anode 314 of an adjacent fuel cell 310.

The plate portion 550 may have a substantially rectangular shape in the x-y plane, such as a substantially square shape in the x-y plane. However, other suitable shapes may be used. The z-direction, which is the stacking direction of the fuel cells 310 and the interconnects 500 in the fuel cell stack 620, is normal to the x-y plane. The x-y plane may be a horizontal plane and the z-direction may be a vertical direction in one embodiment. The interconnect 500 may also include a first fuel inlet 522a and a second fuel inlet 522b (i.e., fuel inlet openings (e.g., through-holes)) in the plate portion 550. The interconnect 500 may also include a first fuel outlet 524a and a second fuel outlet 524b (i.e., fuel outlet openings (e.g., through-holes)) which may also be referred to as anode exhaust outlets in the plate portion 550. As illustrated in FIG. 4, the first fuel inlet 522a, second fuel inlet 522b, first fuel outlet 524a and second fuel outlet 524b may be disposed outside of the perimeter of the fuel cells 310 such that the fuel cells 310 may not need to include through holes for fuel flow. It should be noted that the interconnect 500 may include more than or fewer than two fuel inlets and more than or fewer than two fuel outlets.

The size and shape of each of the first fuel inlet 522a, second fuel inlet 522b, first fuel outlet 524a and second fuel outlet 524b may be substantially the same. The shape may include a substantially rectangular shape in the x-y plane, such as a substantially elongated rectangular shape with rounded corners in the x-y plane. However, other suitable shapes may be used.

In one embodiment, a width of each of the first fuel inlet 522a, second fuel inlet 522b, first fuel outlet 524a and second fuel outlet 524b in the y-direction may in less than, such as in a range from 15% to 35%, of a length of each of the first fuel inlet 522a, second fuel inlet 522b, first fuel outlet 524a and second fuel outlet 524b in the x-direction, respectively. The x-direction is parallel to the airflow direction A, while the y-direction is perpendicular to the airflow direction A. The length of each of the first fuel inlet 522a, second fuel inlet 522b, first fuel outlet 524a and second fuel outlet 524b in the x-direction may also be in a range from 15% to 40% of a length of the interconnect 500 in the x-direction. A width of each of the first fuel inlet 522a, second fuel inlet 522b, first fuel outlet 524a and second fuel outlet 524b in the y-direction may also be in a range from 5% to 20% of the width of the interconnect 500 in the y-direction.

The interconnect 500 may further include a plurality of fuel channels 508A on the fuel side 602. The fuel channels 508A may connect the first fuel inlet 522a to the first fuel outlet 524a and connect the second fuel inlet 522b to the second fuel outlet 524b. The interconnect 500 may also include a plurality of fuel ribs 512A projecting from the plate portion 550 on the fuel side 602 of the interconnect 500. The plurality of fuel channels 508A may be located between the plurality of fuel ribs 512A.

The first fuel inlets 522a and second fuel inlets 522b of the interconnects 500 in the fuel cell stack 620 may be substantially aligned in the z-direction so as to constitute respective fuel inlet risers 603 in the fuel cell stack 620. The first fuel outlets 524a and second fuel outlets 524b of the interconnects 500 in the fuel cell stack 620 may be substantially aligned in the z-direction so as to constitute respective fuel outlet risers 605 in the fuel cell stack 620.

The interconnect 500 (e.g., plate portion 550, fuel channels 508A, fuel ribs 512A, etc.) may include (e.g., be made from) an electrically conductive material. For example, the interconnect 500 may include a chromium alloy, such as a Cr—Fe alloy. The interconnect 500 may be fabricated using a powder metallurgy technique that includes pressing and sintering a Cr—Fe powder, which may be a mixture of Cr and Fe powders or an Cr—Fe alloy powder, to form a Cr—Fe interconnect in a desired size and shape (e.g., a “net shape” or “near net shape” process). A typical chromium-alloy interconnect 500 may include more than about 90% chromium by weight, such as about 94-96% (e.g., 95%) chromium by weight. The interconnect 500 may also contain less than about 10% iron by weight, such as about 4-6% (e.g., 5%) iron by weight, and may contain less than about 2% by weight, such as about zero to 1% by weight, of other materials, such as yttrium or yttria, as well as residual or unavoidable impurities. The distribution of chromium and iron may be uniform throughout interconnect 500, or may contain iron-rich regions near the fuel side 602 of the interconnect 500.

A surface of the interconnect 500 that in operation may be exposed to an oxidizing environment (e.g., air), such as the air side 601 (e.g., cathode-facing side) of the interconnect 500, may be coated with a protective coating layer in order to decrease the growth rate of a chromium oxide surface layer on the interconnect and to suppress evaporation of chromium vapor species which can poison the fuel cell cathode 316. Typically, the coating layer, which may include a perovskite such as lanthanum strontium manganite (LSM), may be formed using a spray coating or dip coating process. Alternatively, other metal oxide coatings, such as a spinel, such as an (Mn, Co)₃O₄ spinel (MCO), can be used instead of or in addition to LSM. Any spinel having the composition Mn₂-xCo₁+xO₄ (0≤x≤1) or written as z(Mn₃O₄)+(1−z)(Co₃O₄), where (⅓≤z≤⅔) or written as (Mn, Co)₃O₄ may be used. In other embodiments, a mixed layer of LSM and MCO, or a stack of LSM and MCO layers may be used as the coating layer.

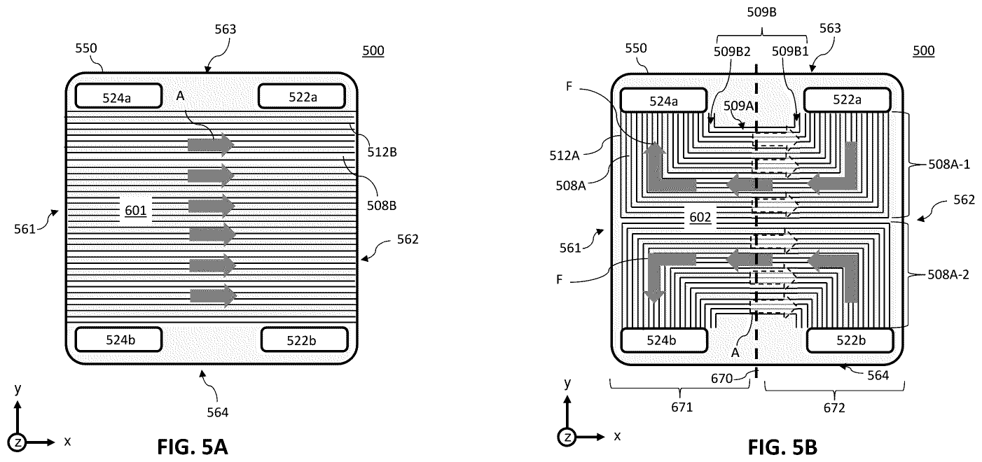

FIG. 5A is a plan view of the air side 601 of the interconnect 500, according to the first embodiment. FIG. 5B is a plan view of the fuel side 602 of the interconnect 500, according to the first embodiment. It should be noted that each of the interconnect 500, first and second fuel inlets 522a, 522b and first and second fuel outlets 524a, 524b, may or may not have rounded corners as illustrated in FIGS. 5A and 5B.

As illustrated in FIG. 5A, the plate portion 550 includes a first end 561 and a second end 562 opposite the first end 561 in the x-direction (first direction). The first end may face the cathode recuperator 120 and the second end may face the ATO 150 in the fuel cell system 10. The airflow direction A is in the x-direction from the first end 561 to the second end 562 on the air side 601 of plate portion of the interconnect 500.

Referring to FIGS. 4 and 5B, an imaginary vertical y-z plane 670 bisects the interconnect 500 midway along the x-direction (e.g., the air flow direction) and divides the interconnect 500 into a first lateral half 671 and a second lateral half 672. The first lateral half 671 is located closer to the cathode recuperator 120 than to the ATO 150 in the fuel cell system 10. The second lateral half 672 is located closer to the ATO 150 than to the cathode recuperator 120 in the fuel cell system 10. Thus, the first lateral half 671 receives less total radiative heating than the second lateral half 672. In other words, the cathode recuperator 120 which operates at a lower temperature than the ATO 150 supplies a lower amount of radiative heating to the first lateral half 671 than the amount of radiative heating that the second lateral half receives from the ATO 150. Therefore, the second lateral half 672 is the warmer half and the first lateral half 671 is the colder half.

In one embodiment, the fuel cell stack 620 includes a plurality of the interconnects 500 (or interconnects 500′ or 500″ of the second and third embodiments described below) alternating with a plurality of fuel cells 310 along a third direction (e.g., the vertical z-direction) perpendicular to the first direction (e.g., the horizontal x-direction) and the second direction (e.g., the horizontal y-direction). The first end 561 of the plate portion 550 is located on a first side 621 of the fuel cell stack 620 and the second end 562 of the plate portion 550 is located on a second side 621 of the fuel cell stack 620. The first side 621 of the fuel cell stack faces a first component (e.g., cathode recuperator) 120 of the fuel cell system 10, and the second side 622 of the fuel cell stack 620 faces the second component (e.g., the ATO) 150 of the fuel cell system 10.

The imaginary vertical y-z plane 670 is located in the middle of the fuel cell stack 620 and bisects the fuel cell stack 620 midway along the x-direction (e.g., the air flow direction) and divides the fuel cell stack into a first lateral half 623 and a second lateral half 624. Thus, the fuel cell stack 620 includes the first lateral half 623 located between the first side 621 of the fuel cell stack 620 and the middle 670 of the fuel cell stack 620, and the second lateral half 624 located between the second side 622 of the fuel cell stack 620 and the middle 670 of the fuel cell stack 620.

In one embodiment, at least 60% of the total fuel inlet opening 522 area is located in the second lateral half 672 of the interconnect 500, 500′ or 500″ and at most 40% of the total fuel inlet opening 522 area is located in the first lateral half 671 of the interconnect 500, 500′ or 500″. At least 60% of all fuel reformation reaction occurs at a fuel cell 310 anode 314 over the second lateral half 672 of the interconnect 500, 500′ or 500″, and at most 40% of all fuel reformation reaction occurs at the fuel cell 310 anode 314 over the first lateral half 671 of the interconnect 500, 500′ or 500″.

In the first embodiment, both the first fuel inlet 522a and the second fuel inlet 522b are located in the second lateral half 672 of the interconnect 500, adjacent to the second end 562 of the plate portion 550. Therefore, all fuel inlets in the interconnect 500 of the first embodiment are located in the warmer second lateral half 672 of the interconnect 500. Thus, more than 75% of all fuel reformation, such as 80 to 100% of the fuel reformation reaction will occur at the anode 314 over the warmer second half of the interconnect 500. Thus, the warmer second lateral half 672 of the interconnect will be cooled by the endothermic reformation reaction to a greater extent than the cooler first lateral half 671 of the interconnect 500. This reduces the maximum temperature and the temperature gradient across the interconnect.

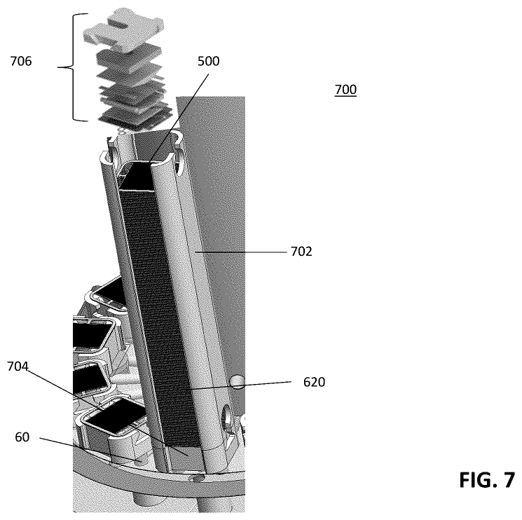

The plate portion 550 may further include a third end 563 and a fourth end 564 opposite the third end 563 in the y-direction (second direction perpendicular to the first direction). The third and fourth ends may be located adjacent to side baffles 702 which surround the fuel cell stack 620, as shown in FIG. 7 and described in more detail below. The first fuel inlet 522a may be located adjacent to the third end 563 of the plate portion 550 and the second fuel inlet 522b may be located adjacent the fourth end 564 of the plate portion 550. The first fuel outlet 524a may be located adjacent to the third end 563 of the plate portion 550 and the second fuel outlet 524b may be located adjacent the fourth end 564 of the plate portion 550.

The plate portion 550 may further include a plurality of air channels 508B on the air side 601 of the plate portion 550. The air channels 508B may be substantially linear and extend continuously from an air inlet edge at the first end 561 (e.g., the edge of the first end 561) of the plate portion 550 to an air outlet edge at the second end 562 (e.g., the edge of the second end 562) of the plate portion 550. The plate portion 550 may also include a plurality of air ribs 512B projecting from the air side 601. The plurality of air channels 508B may be located between the plurality of air ribs 512B. The air channels 508B and air ribs 512B may include (e.g., be made from) a material substantially the same as the plate portion 550.

As illustrated by the directional arrows in FIG. 5A, in operation, the air inlet stream may flow in the air channels 508B from the air inlet edge at the first end 561 of the plate portion 550 to the air outlet edge at the second end 562 of the plate portion 550 along the x-direction. It should be noted that the air flow is in a direction from the fuel outlets 524a, 524b toward the fuel inlets 522a, 522b, respectively.

As illustrated in FIG. 5B, the fuel channels 508A may include first fuel channels 508A-1 connecting the first fuel inlet 522a to the first fuel outlet 524a, and second fuel channels 508A-2 connecting the second fuel inlet 522b to the second fuel outlet 524b. In the first embodiment, there is no fuel channel path between the first fuel channels 508A-1 and the second fuel outlet 524b, and there is no fuel channel path between the second fuel channels 508A-2 and the first fuel outlet 524a. Thus, in the first embodiment, the fuel does not flow through the fuel channel path from the first fuel inlet 522a to the second fuel outlet 524b, and the fuel also does not flow through the fuel channel path from the second fuel inlet 522b to the first fuel outlet 524a across the fuel side 602 of the interconnect 500. The fuel channels 508A may also include a first channel portion 509A extending lengthwise in the x-direction (first direction) and a second channel portion 509B extending lengthwise in the y-direction (second direction). The second channel portion 509B may also include a second channel portion inlet part 509B1 connected to the first fuel inlet 522a, and a second channel portion outlet part 509B2 connected to the first fuel outlet 524a. The first channel portion 509A may connect the second channel portion inlet part 509B1 to the second channel portion outlet part 509B2.

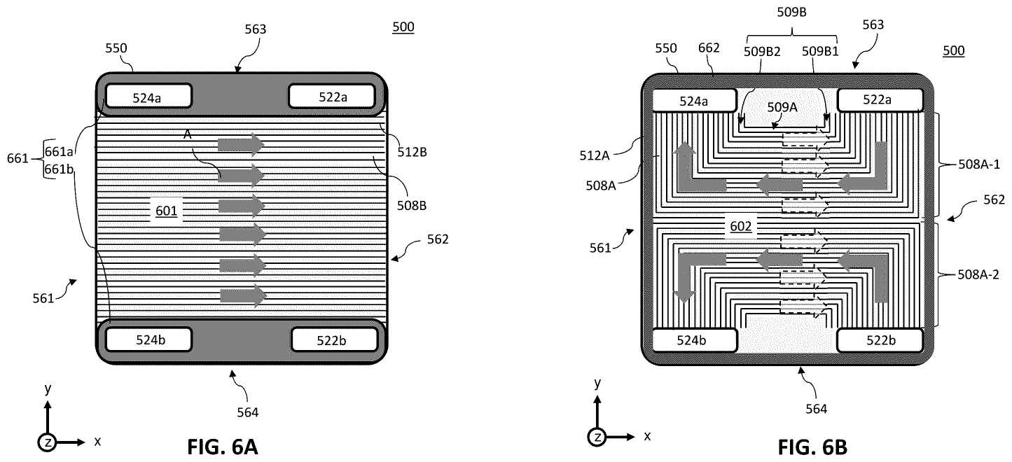

FIG. 6A is a plan view of a riser seal 661 on the air side 601 of the interconnect 500, according to the first embodiment. FIG. 6B is a plan view of a perimeter seal 662 on the fuel side 602 of the interconnect 500, according to the first embodiment.

As illustrated in FIG. 6A, the riser seal 661 may include a first riser seal 661a located on the air side 601 of the interconnect 500 at the third end 563 of the plate portion 550. The riser seal 661 also include a second riser seal 661b located on the air side 601 of the interconnect 500 at the fourth end 564 of the plate portion 550. Each of the first riser seal 661a and the second riser seal 661b may have a substantially rectangular frame shape and may contain rounded corners.

An air flow field including the air channels 508B may be formed between the first riser seal 661a and the second riser seal 661b. A riser seal surface may be located on the plate portion 550 on opposing sides of the air flow field. The first riser seal 661a and second riser seal 661b may be located on the riser seal surface. The riser seal surface may surround the first and second fuel inlets 522a, 522b and the first and second fuel outlets 524a, 524b. The riser seal surface may be substantially flat and smooth so the first riser seal 661a and the second riser seal 661b may form a substantially air-tight seal with the riser seal surface. The riser seals 661 may inhibit (e.g., prevent) fuel and/or anode exhaust from entering the air flow field and contacting the cathode 316 of the fuel cell 310. The riser seals 661 may also operate to prevent fuel from leaking out of the fuel cell stack 620 from fuel inlet risers 603 and fuel outlet risers 605.

Referring to FIG. 6B, the fuel side 602 of the interconnect 500 may be divided into two fuel flow fields including the first fuel channels 508A-1 and the second fuel flow channels 508A-2, respectively. A perimeter seal surface may surround the fuel flow fields and the first and second fuel inlets 522a, 522b and first and second fuel outlets 524a, 524b. A perimeter seal 662 may be disposed on the perimeter seal surface. The perimeter seal 662 may have a substantially square frame shape and may contain rounded corners.

The perimeter seal 662 may be configured to inhibit (e.g., prevent) air from entering the fuel flow fields and contacting the anode on an adjacent fuel cell 310. The perimeter seal 662 may also operate to prevent fuel from exiting the fuel inlet risers 603 and fuel outlet risers 605 and leaking out of the fuel cell stack 620.

Each of the riser seal 661 and the perimeter seal 662 may include a glass or a glass-ceramic seal material. The seal material may have a low electrical conductivity. In some embodiments, the riser seal 661 and perimeter seal 662 may be formed by printing one or more layers of seal material on the interconnect 500 (e.g., on the plate portion 550) followed by sintering.

FIG. 7 illustrates a fuel cell column 700 that may include one or more fuel cell stacks 620 including the fuel cells 310 separated by the interconnects 500, according to one or more embodiments. One or more fuel cell columns 700 may be thermally integrated with other components (e.g., an anode tail gas oxidizer 150, heat exchangers, such as the cathode recuperator 120, fluid conduits and manifolds, etc.) in a common enclosure or “hotbox” 100 of the fuel cell system 10.

The fuel cell column 700 may include side baffles 702, a fuel plenum 704, and a compression assembly 706. The side baffles 702 may be formed of a ceramic material and may be disposed on opposing third and fourth sides of the fuel cell column 700. The side baffles 702 may connect the fuel plenum 704 and the compression assembly 706, such that the compression assembly 706 may apply pressure to the one or more fuel cell stacks 620. The air enters and exits the fuel cell stack 620 between the side baffles 702. The fuel plenum 704 may be disposed below the fuel cell stack 620 and may be configured to provide a fuel feed to the fuel cell stack 620, and may receive an anode fuel exhaust from the fuel cell stack 620. The fuel plenum 704 may be connected to fuel inlet and outlet conduits 60 which are located below the fuel plenum 704. The fuel inlet risers 603 (see FIG. 4) may be configured to distribute fuel received from the fuel plenum 704 to the fuel cells 310. The fuel outlet risers 605 (see FIG. 4) may be configured to provide anode exhaust received from the fuel cells 310 to the fuel plenum 704.

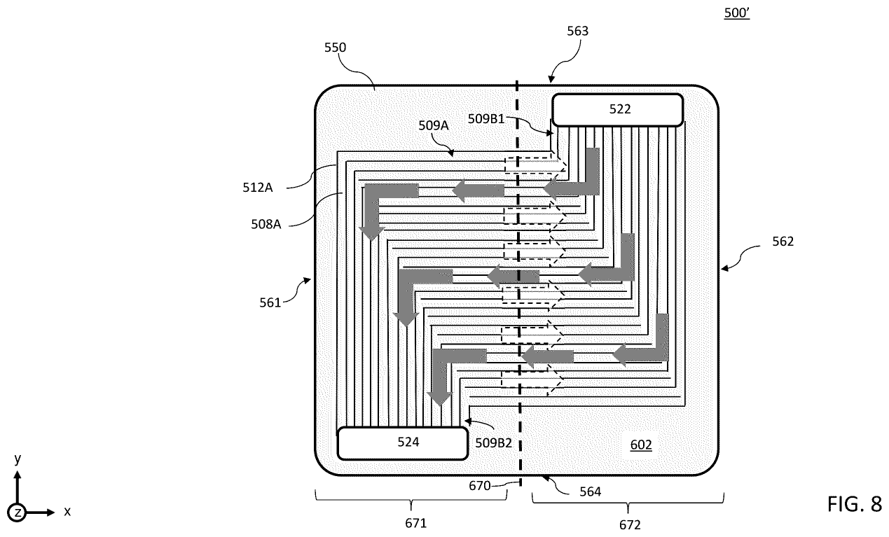

FIG. 8 is a plan view of the fuel side 602 of the interconnect 500′ according to a second embodiment. The air side 601 may be substantially the same as described above with reference to FIG. 5A. For ease of understanding, the air flow on the air side 601 (e.g., from the first end 561 of interconnect 500′ to the second end 562 of interconnect 500′) is indicated by the dashed directional arrows in FIG. 8.

As illustrated in FIG. 8, the interconnect 500′ may include the single fuel inlet 522 on the third end 563 of the plate portion and adjacent to the second end 562 of the plate portion 550. The interconnect 500′ may also include the single fuel outlet 524 on the fourth end 564 of the plate portion adjacent the first end 561 of the plate portion 550. Each of the fuel channels 508A may also include a first channel portion 509A extending lengthwise in the x-direction (first direction) and second channel portions 509B extending lengthwise in the y-direction (second direction). The second channel portions 509B may also include a second channel portion inlet part 509B1 connected to the fuel inlet 522, and a second channel portion outlet part 509B2 connected to the fuel outlet 524. The first channel portion 509A may connect the second channel portion inlet part 509B1 to the second channel portion outlet part 509B2.

In the second embodiment, the sole fuel inlet 522 is located in the warmer second lateral half 672 of the interconnect 500′, adjacent to the second end 562 of the plate portion 550. Therefore, no fuel inlets in the interconnect 500′ of the second embodiment are located in the colder second half 671 of the interconnect 500′. Thus, more than 75% of all fuel reformation, such as 80 to 100% of the fuel reformation reaction will occur at the anode 314 adjacent the warmer second half 672 of the interconnect 500′. Thus, the warmer second lateral half 672 of the interconnect will be cooled by the endothermic reformation reaction to a greater extent than the cooler first lateral half 671 of the interconnect 500′. This reduces the maximum temperature and the temperature gradient across the interconnect.

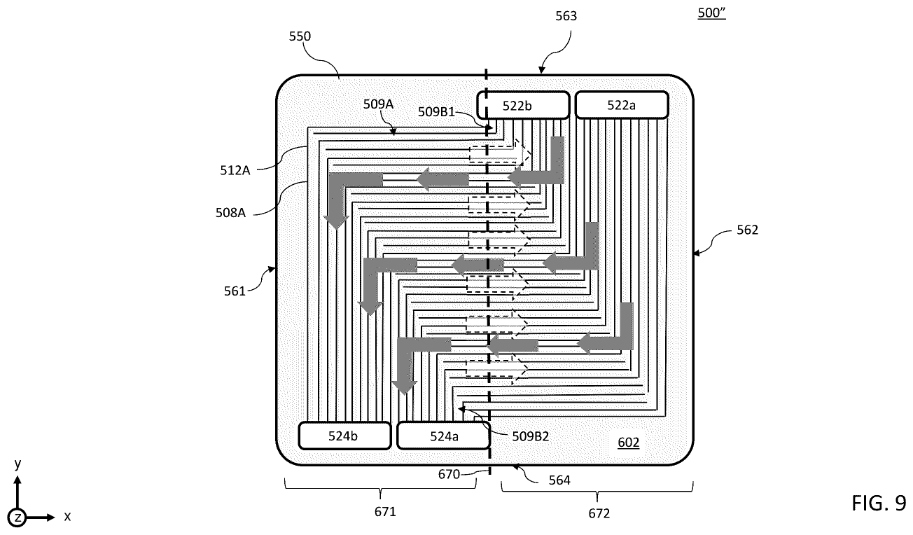

FIG. 9 is a plan view of the fuel side 602 of the interconnect 500″ according to the third embodiment. The air side 601 may be substantially the same as described above with reference to FIG. 5A. For ease of understanding, the air flow on the air side 601 (e.g., from the first end 561 of interconnect 500″ to the second end 562 of interconnect 500″) is indicated by the dashed directional arrows in FIG. 9.

As illustrated in FIG. 9, the interconnect 500″ may include the first and second fuel inlets 522a, 522b on the third end 563 of the plate portion 550 and adjacent to the second end 562 of the plate portion 550. In contrast to the first embodiment shown in FIG. 5B, the first and second fuel inlets 522a, 522b may be separated (in the x-direction) by a small space, so that both the first and second fuel inlets 522a, 522b may be located in the same corner of the interconnect 500″ (e.g., the corner of the second end 562 and third end 563 of the plate portion 550).

The interconnect 500″ may also include the first and second fuel outlets 524a, 524b on the fourth end 564 of the plate portion 550 and adjacent the first end 561 of the plate portion 550. In contrast to the first embodiment shown in FIG. 5B, the first and second fuel outlets 524a, 524b may be separated (in the x-direction) by a small space, so that both the first and second fuel outlets 524a, 524b may be located in the same corner of the interconnect 500″ (e.g., the corner of the first end 561 and fourth end 564 of the plate portion 550).

The fuel channels 508A may include a first channel portion 509A extending lengthwise in the x-direction (first direction) and second channel portions 509B extending lengthwise in the y-direction (second direction). The second channel portions 509B may also include a second channel portion inlet part 509B1 connected to the first and second fuel inlets 522a, 522b, and a second channel portion outlet part 509B2 connected to the first and second fuel outlets 524a, 524b. The first channel portion 509A may connect the second channel portion inlet part 509B1 to the second channel portion outlet part 509B2.

In contrast to the first embodiment shown in FIG. 5B, in the third embodiment shown in FIG. 9, the first fuel inlet 522a is located in the second lateral half 672 of the interconnect 500″, adjacent to the second end 562 of the plate portion 550, while at least a portion of the second fuel inlet 522b is located in the first lateral half 671 of the interconnect 500″. However, more than 50%, such as at least 60% of the total area of the fuel inlets 522a, 522b is located in the warmer second lateral half 672 of the interconnect 500″. For example, 60% to 99% of the total area of the fuel inlets 522a, 522b is located in the warmer second lateral half 672 of the interconnect 500″, while at most 40%, such as 1% to 40% of the total area of the fuel inlets 522a, 522b is located in the colder first lateral half 671 of the interconnect 500″. Thus, more than 50%, such as at least 60% of all fuel reformation, such as 60% to 99% of the fuel reformation reaction will occur at the anode 314 adjacent the warmer second lateral half 672 of the interconnect 500″, while less than 50%, such as at most 40% of all fuel reformation, such as 1% to 40% of the fuel reformation reaction will occur at the anode 314 adjacent the colder first lateral half 671 of the interconnect 500″. Thus, the warmer second lateral half 672 of the interconnect will be cooled by the endothermic reformation reaction to a greater extent than the cooler first lateral half 671 of the interconnect 500″. This reduces the maximum temperature and the temperature gradient across the interconnect.

According to various embodiments, a method of operating the fuel cell system 10 comprises providing a fuel inlet stream and an air inlet stream into a fuel cell stack 620 having a first side 621 and a second side 622. The fuel cell stack 620 comprises fuel cells 310 alternating with interconnects 500, 500′ and/or 500″. The method also includes reforming fuel from the fuel inlet stream at anodes 314 of the fuel cells 310, operating a first component 120 of the fuel cell system 10 at a first temperature and operating a second component 150 of the fuel cell system at a second temperature higher (e.g., at least 100° C. higher, such as 100 to 300° C. higher) than the first temperature. As shown in FIG. 4, the first side 621 of the fuel cell stack 620 faces the first component 120, and the second side 622 of the fuel cell stack 620 faces the second component 150. Greater than 50% of the reforming the fuel at the anodes 314 of the fuel cells 310 occurs in a second half 624 of the fuel cell stack 620 between the second side 622 of the fuel cell stack 620 and a middle 670 of the fuel cell stack 620.

In one embodiment, the second component comprises an anode tailgas oxidizer (ATO) 150 in which at least a portion of the fuel exhaust from the fuel cell stack 620 is oxidized using air exhaust from the fuel cell stack 620. The first component comprises a cathode recuperator heat exchanger 120 in which the air inlet stream is heated using an exhaust from the ATO 150 before the air inlet stream is provided into the fuel cell stack 620. As shown in FIG. 4, the fuel cell stack 620 is located between the cathode recuperator heat exchanger 120 and the ATO 150.

In some embodiments, the fuel comprises methane (e.g., pure methane or natural gas which includes methane as a component), and the fuel inlet stream comprises the methane and H₂O (e.g., steam and/or water vapor). As described above, the first half 623 of the fuel cell stack 620 located between the first side 621 of the fuel cell stack and the middle 670 of the fuel cell stack 620 receives less total radiative heating than the second half 624 of the fuel cell stack 620. The fuel is reformed using an endothermic steam-methane reformation reaction which cools the second half 624 of the fuel cell stack 620 more than the first half 623 of the fuel cell stack 620 to reduce a thermal gradient between the first half 623 and the second half 624 of the fuel cell stack 620.

As shown in FIG. 4, in one embodiment the fuel cells alternate with the interconnects along a vertical direction (e.g., z-direction). In this embodiment, the first half 623 of the fuel cell stack comprises a first lateral half of the fuel cell stack, and the second half 624 of the fuel cell stack comprises a second lateral half of the fuel cell stack 620. The imaginary vertical plane 670 which is normal to a horizontal air inlet stream flow direction (e.g., x-direction) extends through the middle of the fuel cell stack (when measured along the x-direction).

In some embodiments, the interconnect 500, 500′ and/or 500″ comprises a first lateral half 671 located in the first lateral half 623 of the fuel cell stack 620, and a second lateral half 672 located in the second lateral half 624 of the fuel cell stack, and separated from the first lateral half 671 of the interconnect by the imaginary plane 670 which is normal to the first direction (e.g., x-direction) and which bisects the interconnect midway along the first direction. As discussed above, more than 50% of a total fuel inlet opening 522 area is located in the second half 672 of the interconnect, and less than 50% of the total fuel inlet opening 522 area is located in the first half 671 of the interconnect. In some embodiments, at least 60% of fuel reformation at the anodes 314 of the fuel cells 310 occurs in the second half 623 of the fuel cell stack 620, and at most 40% of the fuel reformation at the anodes 314 of the fuel cells 310 occurs in the first half 623 of the fuel cell stack 620.

While solid oxide fuel cell interconnects, end plates, and electrolytes are described above in various embodiments, embodiments can include any other fuel cell interconnects or end plates, such as molten carbonate, phosphoric acid or PEM fuel cell electrolytes, interconnects or end plates, or any other shaped metal or metal alloy or compacted metal powder or ceramic objects not associated with fuel cell systems.

The foregoing method descriptions are provided merely as illustrative examples and are not intended to require or imply that the steps of the various embodiments must be performed in the order presented. As will be appreciated by one of skill in the art, the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular. Further, any step or component of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. An interconnect for a fuel cell system, comprising:
a plate portion, comprising:
a first end and a second end opposite the first end in a first direction; and
a third end and a fourth end opposite the third end in a second direction perpendicular to the first direction;
at least one fuel inlet opening and at least one fuel outlet opening in the plate portion; and
a plurality of fuel channels connecting the at least one fuel inlet opening to the at least one fuel outlet opening,
wherein:
the interconnect comprises a first lateral half and a second lateral half separated by an imaginary plane which is normal to the first direction and which bisects the interconnect midway along the first direction;
the first lateral half is located closer to a first component than to a second component of the fuel cell system when the interconnect is located in a fuel cell stack located in the fuel cell system;
the second lateral half is located closer to the second component than to the first component of the fuel cell system when the interconnect is located in the fuel cell stack located in the fuel cell system;
more than 50% of a total fuel inlet opening area is located in the second lateral half of the interconnect; and
the first component operates at a lower temperature than the second component during operation of the fuel cell system.

2. The interconnect of claim 1, further comprising an air inlet edge located on the first end of the plate portion and an air outlet edge located on the second end of the plate portion.

3. The interconnect of claim 2, wherein:
the interconnect is internally manifolded for fuel and externally manifolded for air;
the plate portion comprises an air side and a fuel side located opposite to the air side; and
the plurality of fuel channels are located on the fuel side and comprise a first channel portion extending lengthwise in the first direction and at least one second channel portion extending lengthwise in the second direction.

4. The interconnect of claim 3, further comprising:
a plurality of fuel ribs projecting from the fuel side, wherein the plurality of fuel channels are located between the plurality of fuel ribs; and
a plurality of air ribs projecting from the air side, and a plurality of air channels located between the plurality of air ribs, wherein the plurality of air channels extends in the first direction from the air inlet edge to the air outlet edge.

5. The interconnect of claim 4, wherein:
the at least one fuel inlet opening comprises a first fuel inlet opening located on the third end of the plate portion and a second fuel inlet opening located on the fourth end of the plate portion; and
the at least one fuel outlet opening comprises a first fuel outlet opening located on the third end of the plate portion and a second fuel outlet opening located on the fourth end of the plate portion.

6. The interconnect of claim 5, wherein:
at least one second channel portion inlet part is connected to the first fuel inlet opening; and
at least one second channel portion outlet part is connected to the first fuel outlet opening, wherein the first channel portion connects the second channel portion inlet part to the second channel portion outlet part.

7. The interconnect of claim 4, wherein:
the at least one fuel inlet opening comprises a single fuel inlet opening located on the third end of the plate portion and adjacent to the second end of the plate portion; and
the at least one fuel outlet opening comprises a single fuel outlet opening located on the fourth end of the plate portion adjacent to the first end of the plate portion.

8. The interconnect of claim 7, wherein:
at least one second channel portion inlet part is connected to the single fuel inlet opening; and
at least one second channel portion outlet part is connected to the single fuel outlet opening, wherein the first channel portion connects the second channel portion inlet part to the second channel portion outlet part.

9. The interconnect of claim 4, wherein:
the at least one fuel inlet opening comprises a first fuel inlet opening and a second fuel inlet opening located on the third end of the plate portion and adjacent to the second end of the plate portion; and
the at least one fuel outlet opening comprises a first fuel outlet opening and a second fuel outlet opening located on the fourth end of the plate portion adjacent to the first end of the plate portion.

10. The interconnect of claim 9, wherein:
at least one second channel portion inlet part is connected to the first fuel inlet opening;
at least one second channel portion outlet part is connected to the first fuel outlet opening, wherein a first channel in the first channel portion connects the second channel portion inlet part to the second channel portion outlet part;
a different second channel inlet part is connected to the second fuel inlet opening; and
a different second channel portion outlet part is connected to the second fuel outlet opening, wherein a different channel in the first channel portion connects the different second channel portion inlet part to the different second channel portion outlet part.

11. The interconnect of claim 1, wherein:
at least 60% of the total fuel inlet opening area is located in the second lateral half of the interconnect, and at most 40% of the total fuel inlet opening area is located in the first lateral half of the interconnect;
the first component comprises a cathode recuperator heat exchanger;
the second component comprises an anode tailgas oxidizer; and
at least 60% of all fuel reformation occurs over the second lateral half of the interconnect, and at most 40% of all fuel reformation occurs over the first lateral half of the interconnect.

12. A fuel cell system, comprising:
a fuel cell stack comprising a plurality of the interconnects of claim 1 alternating with a plurality of fuel cells along a third direction perpendicular to the first direction and to the second direction, wherein the first end of the plate portion is located on a first side of the fuel cell stack and the second end of the plate portion is located on a second side of the fuel cell stack;
the first side of the fuel cell stack faces the first component; and
the second side of the fuel cell stack faces the second component.

13. The fuel cell system of claim 12, wherein:
the fuel cells comprise solid oxide fuel cells;
the first and second directions comprise horizontal directions;
the third direction comprises a vertical direction;
the first component comprises a cathode recuperator heat exchanger;
the second component comprises an anode tailgas oxidizer;
the fuel cell stack is located horizontally between the cathode recuperator heat exchanger and the anode tailgas oxidizer;
at least 60% of the total fuel inlet opening area is located in the second lateral half of the fuel cell stack, and at most 40% of the total fuel inlet opening area is located in the first lateral half of the fuel cell stack; and
at least 60% of all fuel reformation occurs over the second lateral half of the fuel cell stack, and at most 40% of all fuel reformation occurs over the first lateral half of the fuel cell stack.

14. A method of operating a fuel cell system, comprising:
providing a fuel inlet stream and an air inlet stream into a fuel cell stack having a first side and a second side, wherein the fuel cell stack comprises fuel cells alternating with interconnects;
reforming fuel from the fuel inlet stream at anodes of the fuel cells;
operating a first component of the fuel cell system at a first temperature; and
operating a second component of the fuel cell system at a second temperature higher than the first temperature,
wherein:
the first side of the fuel cell stack faces the first component and the second side of the fuel cell stack faces the second component; and
greater than 50% of the fuel reformation at the anodes of the fuel cells occurs in a second half of the fuel cell stack between the second side of the fuel cell stack and a middle of the fuel cell stack.

15. The method of claim 14, wherein:
the second component comprises an anode tailgas oxidizer (ATO) in which a fuel exhaust from the fuel cell stack is oxidized using at least some air exhaust from the fuel cell stack;
the first component comprises a cathode recuperator heat exchanger in which the air inlet stream is heated using an exhaust stream from the ATO before the air inlet stream is provided into the fuel cell stack; and
the fuel cell stack is located between the cathode recuperator heat exchanger and the anode tailgas oxidizer.

16. The method of claim 15, wherein:
the fuel cells comprise solid oxide fuel cells;
the fuel comprises methane;
the fuel inlet stream comprises the methane and H₂O;
a first half of the fuel cell stack located between the first side of the fuel cell stack and the middle of the fuel cell stack receives less total radiative heating than the second half of the fuel cell stack; and
the fuel is reformed using an endothermic steam-methane reformation reaction which cools the second half of the fuel cell stack more than the first half of the fuel cell stack, whereby a thermal gradient between the first half and the second half of the fuel cell stack is reduced.

17. The method of claim 16, wherein:
the fuel cells alternate with the interconnects along a vertical direction;
the first half of the fuel cell stack comprises a first lateral half of the fuel cell stack;
the second half of the fuel cell stack comprises a second lateral half of the fuel cell stack; and
an imaginary vertical plane which is normal to a horizontal air inlet stream flow direction extends through the middle of the fuel cell stack.

18. The method of claim 17, wherein each of the interconnects comprises:
a plate portion, comprising:
a first end and a second end opposite the first end in a first direction; and
a third end and a fourth end opposite the third end in a second direction perpendicular to the first direction;
at least one fuel inlet opening and at least one fuel outlet opening in the plate portion; and
a plurality of fuel channels connecting the at least one fuel inlet opening to the at least one fuel outlet opening.

19. The method of claim 18, wherein:
the interconnect comprises a first lateral half located in the first lateral half of the fuel cell stack, and a second lateral half located in the second lateral half of the fuel cell stack; and
more than 50% of a total fuel inlet opening area is located in the second lateral half of the interconnect, and less than 50% of the total fuel inlet opening area is located in the first lateral half of the interconnect.

20. The method of claim 14, wherein:
at least 60% of the fuel reformation at the anodes of the fuel cells occurs in the second half of the fuel cell stack; and
at most 40% of the fuel reformation at the anodes of the fuel cells occurs in the first half of the fuel cell stack.
